(19) United States
(12) Patent Application Publication
(10) Pub. No.: US 2003/0004795 A1
(43) Pub. Date: Jan. 2, 2003

(54) Method of marketing and delivering professional services

(76) Inventor: Brian Michael Monrad, Toronto (CA)

Correspondence Address: Mark Ming-Jen Yang, 800-885 West Georgia Street, Vancouver, BC, V6C 3H1, CA

(21) Appl. No.: 09/893,053

(22) Filed: Jun. 28, 2001

(51) Int. Cl. G06F 17/60

(52) U.S. Cl. 705/14; 705/10

(57) ABSTRACT

There is disclosed a system and method for attracting clients and delivering professional services by using an expert system. Expert system queries a user regarding a professional end product, and based on the answers to the queries, provides to the user a completed or partially completed professional end product. For the user, the expert system is easily accessible and without charge. The expert system is maintained by an association of professionals. There is also provided a facility for the user to contact such association professionals.

### NOTICE REGARDING COPYRIGHTED MATERIAL

A portion of the disclosure of this patent document contains material which is subject to copyright protection. The copyright owner has no objection to the facsimile reproduction by anyone of the patent document or the patent disclosure as it appears in the public Patent Office file or records but otherwise reserves all copyright rights whatsoever.

### TECHNICAL FIELD

This invention relates to methods for professionals to attract clients, and more particularly to methods of doing so using expert systems.

### BACKGROUND

Professionals have embraced modem technology to advertise their services, as can be seen on many professionals' websites. Many professionals use the Internet solely to make promotional materials available. Some professionals use the Internet to do more, for example by allowing clients to interactively create documents by an expert system for a fee. Another development in the delivery of legal services allows clients to subscribe to legal services which allow the client unlimited access to certain databases of documents, and perhaps telephone support when necessary. A similar system is available in professional insurance plans, which allow the insured access to professional services by paying an insurance premium. Both of these systems require the client to pay before access to the professional services.

Developments such as those described above show how professionals have adapted to the Internet and other communications media, but do not take into account the change in the relationship between professionals and their (existing and potential) clients which has occurred due to the latter now having easy and free access to information which was once almost exclusively available to the former (or was difficult to access without a professional). An example is the publication of court decisions, which was once available almost exclusively in law libraries, law schools, courts, law firms and the like. Now many jurisdictions publish court decisions on the Internet. Likewise statutes and sample contracts are generally available on the Internet.

What is needed is a method and system whereby professionals can take advantage of the easy and free accessibility of information by users of the Internet, and thereby efficiently obtain and serve clients; and whereby users of the Internet can take corresponding advantage of such easily and freely accessible information to improve the quality, cost-effectiveness, and efficiency of professional services performed and the convenience of clients.

### SUMMARY OF THE INVENTION

There is provided a method for a professional to attract clients by marketing to those who have no prior professional relationship with said professional, comprising the steps of: (a) providing at no charge to a public user, the use of an expert system; (b) said expert system providing a Professional End Product in response to said user's input; (c) providing means for facilitating said user's communication with said professional; and (d) inviting said user to communicate with said professional to discuss the provision of professional services for a fee.

### BRIEF DESCRIPTION OF FIGURES

Further objects, features and advantages of the present invention will become more readily apparent to those skilled in the art from the following description of the invention when taken in conjunction with the accompanying drawings, in which:

FIG. 1 is a block diagram showing a system according to the invention;

FIG. 2 is a flow chart of a user using an expert system according to the invention;

FIG. 3 is a flow chart showing the interaction between the user and the professional according to the invention; and

FIG. 4 is a website providing users the use of an expert system according to the invention.

### DETAILED DESCRIPTION OF THE PREFERRED EMBODIMENT

For the purposes of this specification and appended claims (and not for the purpose of describing prior art), a “professional” can be an individual who is a member of a recognized or regulated profession (e.g. lawyers, doctors, dentists, engineers, architects, accountants, dieticians) or not (e.g. lobbyists, computer technicians) and can include any service provider that performs “professional services” (as hereinafter defined) for a fee, based on personal expertise, about a client's particular problem.

For the purposes of this specification and appended claims, “health professionals” mean professionals who provides health related services, including, without limitation, doctors, nurses, dentists, chiropractors, dieticians, and masseuses; “legal professionals” means professionals who provide legal services including, without limitation, lawyers, barristers, solicitors, attorneys, notaries, trade-mark and patent agents; and “financial professionals” mean professionals who provide financial services, including, without limitation, accountants, financial bookkeepers financial advisors, brokers, and trustees.

For the purposes of this specification and appended claims (and not for the purpose of describing prior art), a “Professional Knowledge Base”, in relation to a particular profession, means a database (regardless of the form, whether electronic, printed documents or other form) that contains information of a kind found commonly within the professional expertise of a professional in that particular discipline.

For the purposes of this specification and appended claims (and not for the purpose of describing prior art), a “Professional End Product” means the product or service of the kind commonly created or delivered to satisfy the purpose of a professional engagement by a client, whether the product or service is partially completed or performed and not yet ready for use, or is filly completed and is enjoyed or enjoyable by the client, but excludes a product or service for the identification of a problem for the client as distinct from the solution of that problem.

Thus understood, Professional End Product can take the form of a document or report, whether oral or reduced to writing in electronic form, printed on paper or otherwise. Thus understood, Professional End Product does not include a product or service which is only preparatory, intermediate or ancillary to the purpose of the professional engagement (such as a completed questionnaire or a diagnosis) or is of general information or applicability (i.e. being formed independently of a client's input of particulars). Examples of Professional End Products for the professional engagement of a lawyer include a will, trademark application or contract but do not include the notes developed when interviewing the client for the purposes of developing and delivering such will, application or contract. An example of a Professional End Product for the professional engagement of a doctor might be the development of a treatment (or the performance of a treatment or both) for the rehabilitation of an injured limb but does not include the prior diagnosis of that ailment.

For the purposes of this specification and appended claims (and not for the purpose of describing prior art), an “expert system” comprises a Professional Knowledge Base and means for applying information from the Professional Knowledge Base to a fact situation or set of desired results specified by the user (by inputting data orally or in written or electronic form). The use of the expert system by a user results in a Professional End Product. This could be simply a form with instructions for completion, through to manual or automated document production systems, to computerised expert systems embodying artificial intelligence.

For the purposes of this specification and appended claims (and not for the purpose of describing prior art), “professional services” means the services normally provided by a professional in a professional engagement and includes not only providing Professional End Products but also all products and services ancillary or related thereto. Although Professional End Product may be a will or an incorporation of a corporation, for example, the professional services may include the storage of a will for a client or the keeping of a client's corporate minute books.

For the purposes of this specification and appended claims (and not for the purpose of describing prior art), an “organizer” is an entity that is legally distinct from a professional or association of professionals. An organizer may be an individual, a corporation or other recognized legal entity, as long as it is legally distinct from the professionals or association of professionals.

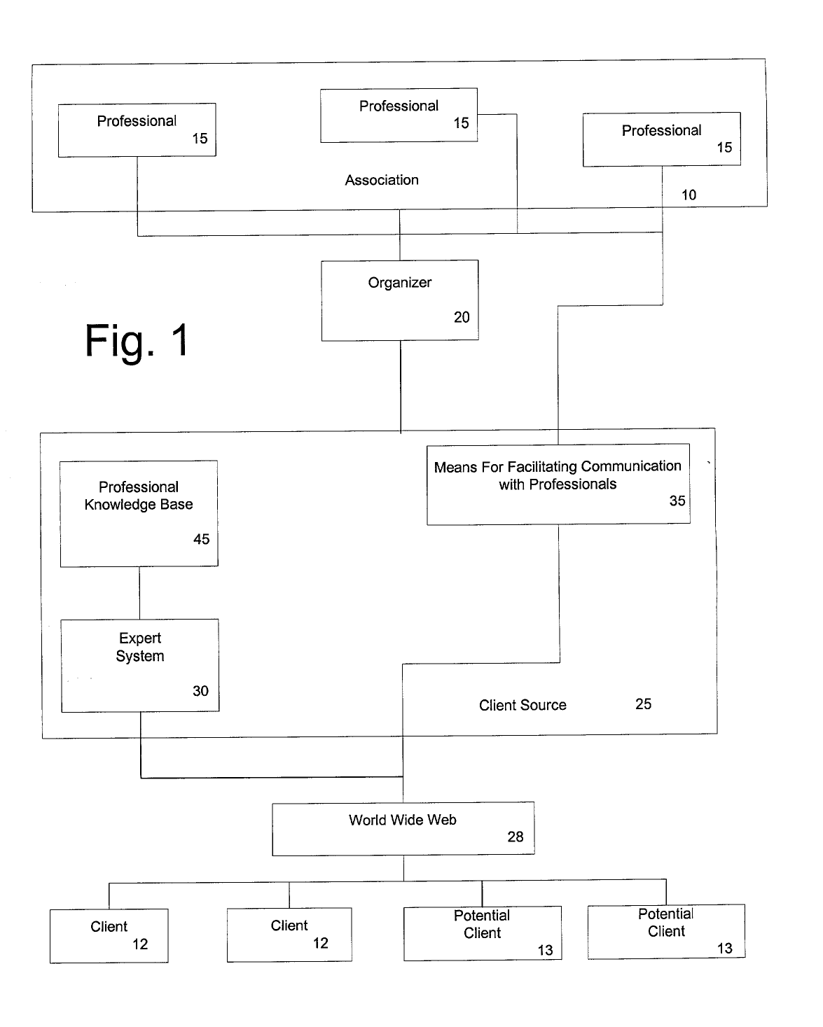

As best seen in FIG. 1, an association 10 of professionals 15 provides professional services to public users 12. For the purposes of this specification by way of example only, mostly legal professionals 15 or lawyers, and legal services are discussed, but the method and system of this invention are appropriate for many other types of professionals.

Association 10 can be a group of lawyers, e.g. a law firm, a corporation or partnership, or a group of otherwise independent lawyers or law firms. Association 10 can be formally organized, such as a formal partnership having a single market identity, or have a more loosely organized existence, perhaps solely to carry out the method according to the invention. The association may include members from more than one professional groups (e.g. lawyers and accountants), and may include members that are not professionals. In some cases, association 10 will be self-organized, for example in a single law firm; and in other cases, an outside organizer 20, as seen in FIG. 1, will be retained to assist in the organization and maintenance of association of otherwise independent lawyers, and assist in the creation, updating and maintenance of the expert system 30 and other activities necessary or ancillary to the method of marketing contemplated by this invention. The professionals 15 preferably pay the organizer 20 for the services provided by the organizer 20, perhaps taken from the collection of a membership fee to join association 10 but other forms of compensation are contemplated, such as contribution of financing or services.

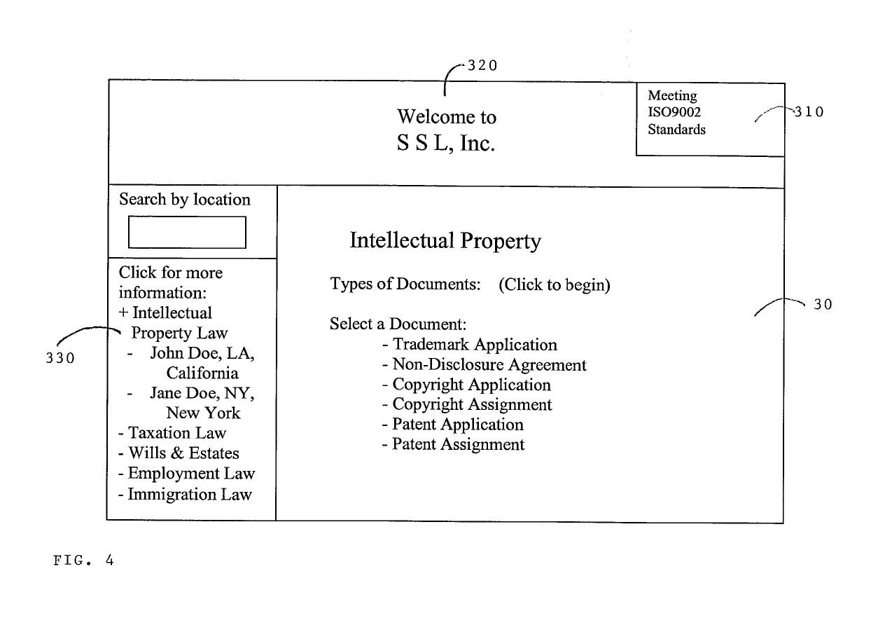

Expert system 30 is available to the public at no charge. Expert system 30 has a Professional Knowledge Base 45 and means for users 12 of the general public to access Professional Knowledge Base 45. Expert system 30 also includes means 35 for facilitating communication of user 12 with the professionals 15 of association 10. Expert system 30 may be a website functioning on the World Wide Web 28, as seen in FIG. 1, but other communications means are possible (e.g. any other means of transferring Professional End Products, such as a telephone request line that can automatically fax documents, may be used to implement expert system 30). A representative website version of expert system 30 is seen in FIG. 4.

Preferably, as seen in FIG. 4, in conjunction with the provision of expert system 30, there will be presented to user 12, the minimum predefined standards 310 for the provision of services by the professionals 15. Such standards 310 are those that all professionals 15 have agreed to comply with, as a condition of membership in association 10. An example of a standard 310 is client pre-approval of all billable professional services to be performed. Another example of a standard 310 is that a professional 15 has International Organization for Standardization's ISO9002 certification. As another example, minimum standard 310 may be as general as providing professional services whose cost and quality reflects the utility of the user 12's input as reflected in the Professional End Product 46. In other words, membership in association 10 will require that the professionals 15 conform to the minimum standards 310, and the minimum standards 310 will presented (visually, orally or by any other multimedia method) to user 12 using expert system 30.

In conjunction with the provision of expert system 30, there will be presented to user 12, the identity 320 of the provider of expert system 30, for example association 10, or the organizer 20. User 12 will be able to use expert system 30 for the creation of a desired Professional End Product 46 by inputting the data requested by expert system 30. In conjunction with the provision of expert system 30, there will be presented to user 12, the name and contact coordinates of at least one professional 15 of association 10 with the capability to perform the professional services related to the Professional End Product 46. The contact coordinates may be phone numbers, addresses, email addresses, and the like. Preferably, there is provided a list 330 of several professionals 15 and their respective contact coordinates that are presented to user 12 according to geographical organization or order selected by user 12 (e.g. by state or province; by city), or by professional expertise (e.g. wills, family law, trademarks) or in other ways useful to user 12; or there is a facility for user 12 to easily search the entire list 330 by professional expertise and/or geography and otherwise. The contact coordinates are simply listed or could be electronic “links” to the websites of their respective professionals 15.

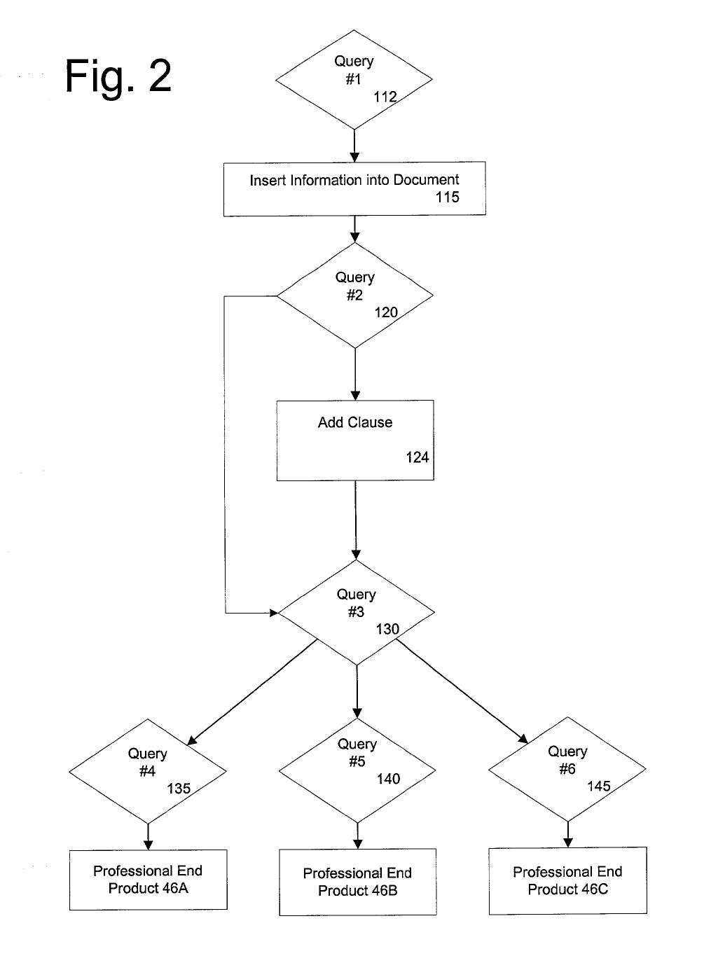

For professionals 15 who normally sell their knowledge and assistance to clients in documentary form, Professional End Products 46 are used to attract users 12 to expert system 30. The types of Professional End Products 46 available will vary according to the types of professionals 15 in association 10. For example, legal Professional End Products 46 may be wills, contracts, trademark applications, plain language versions of “legalese” documents, or specified types of letters; and while normally documents may take the form of textual materials, they could also take the form of purely oral information given to user 12. Such wills, contracts, etc., may be fully completed and ready for use by user 12 or partially completed and not ready for use, as explained below. Referring to FIG. 2, Professional End Products 46 created by expert system 30 and user 12, are without charge. User 12 can obtain and download (e.g. print or electronically store . confidentially at a location chosen by user 12, such as user's personal computer) the Professional End Product 46 created, for subsequent review and use.

Expert system 30 is used to automate many of the tasks normally done by the IS professional 15 using means known in the art. For example, for a trademark application, expert system 30 can be used to query user 12 about the identity and address of the applicant, the basis of the application, etc. In another example, for a contract, expert system 30 can be used to determine the types of clauses that would be appropriate for the contract and to “fill in the blanks” for certain clauses (e.g., by allow the client to select the governing law of a contract).

In practice, as seen in FIG. 2, user 12's interactive use of expert system 30 will lead to the delivery of a Professional End Product 46. Expert system 30 according to FIG. 2 is merely representative of the process that an expert system may take. Expert system 30 will begin the process of providing a document by a query (Query #1 at step 112) for example to insert the appropriate information into the document (step 115). At the next step (Query #2 at step 120) 25 expert system 30 will add a clause to the document (step 125) if the query is answered a certain way. If not, expert system 30 will not add the clause and will skip to the next step (Query #3 at step 130). Query #3, depending on the response, leads to one of Queries #4, #5, or #6 (steps 135, 140, 145, respectively). In the example shown in FIG. 2, expert system 30 leads to Professional End Products 46 A, B or C, depending on the input provided by user 12.

Using a less abstract example, expert system 30 may ask user 12 initial queries to determine the type of Professional End Product 46 sought. Once the precise type of Professional End Product 46 is determined (e.g. an employment contract), expert system 30 may query user 12 to determine the types of clauses to insert (e.g. termination terms and benefits). One important clause is that of the governing law of the employment relationship. As a legal professional may be licensed only to practice within a particular geographic area (e.g. a state or province), expert system 30 should provide a Professional End Product 46 that appropriate to the location or jurisdiction selected by user 12.

The queries will preferably follow a tree branching structure as seen in FIG. 2 to ask appropriate queries based on the previous responses by user 12. Given that the queries asked by a complex expert system 30 may be somewhat complicated or technical (e.g. using legal terminology that may not be understood by user 12), it is important that expert system 30 include options to answer a query with a “don't know”, while allowing user 12 to complete as much as possible the document, being the desired Professional End Product 46, without requiring further assistance.

The query process may be relatively simple, as seen in FIG. 2, or may be complex involving hundreds of queries. Generally, the more complex a document expert system 30 is capable of producing, the more valuable Professional End Product 46 will be to users 12 as a tool and to professionals 15 as a means for attracting users 12.

Such expert systems are well known in the art and are used internally in many professional organizations, such as law firms, but are generally not accessible by users 12, and are certainly not provided to users 12 at no charge.

Expert system 30 must be prepared and maintained, preferably by the professionals 15 and/or the organizer 20. Such maintenance includes the updating, expanding, and monitoring of the quality of Professional End Products 46. Preferably, the organizer monitors the quality of expert system 30 and the Professional End Products 46 produced. For example, professionals 15 as lawyers may be regulated by geographical factors (e.g. state or provincial license to practise law). In consultation with professionals 15, the organizer 20 must ensure that expert system 30 is adapted to be sensitive to local variations to produce a Professional End Product 46 that is relevant in the location specified by user 12. Keeping the Professional End Products 46 and expert system 30 up to date and applicable to each professional's jurisdiction is important, as most of the professionals 15 will practice in professional disciplines that require frequent modifications and improvements to expert system 30 to produce useful Professional End Products 46.

If a user 12 has obtained a Professional End Product 46 from expert system 30, he will, as explained above, also have been presented contact information about contacting a professional 15 who is knowledgeable in the field in which the Professional End Product 46 is relevant. For example, if the Professional End Product 46 is an employment agreement and specified to be usable in the state of California, user 12 will be assisted in the direction of an employment lawyer licensed to practice California employment law (by way of contact coordinates, “hot link” to that lawyer's website where applicable, and the like, as explained above).

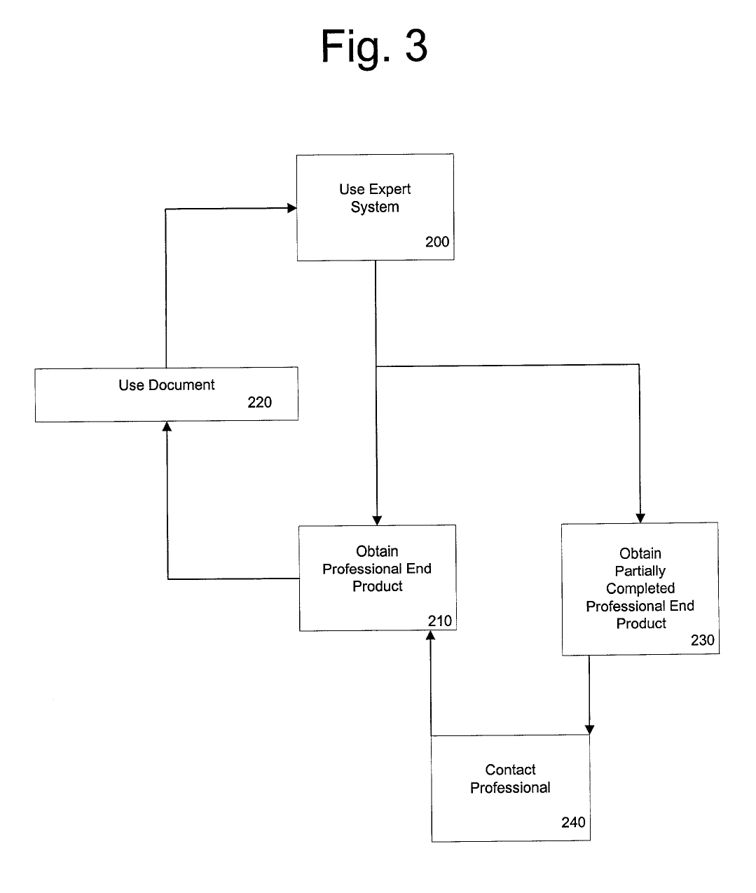

As best seen in FIG. 3, user 12 using expert system (step 200) and obtaining a Professional End Product 46 (step 210), may use it as he sees fit (step 220). Given that user 12 has without charge and conveniently (e.g. by himself at his home computer in the evening) obtained a desired Professional End Product 46 by using expert system 30, user 12 will likely return to that expert system 30 when the need arises for another Professional End Product 46. If user 12 obtains a Professional End Product 46 for which user 12 requires no further professional services to use, it is likely to be the sort of Professional End Product 46 that is inefficient for a professional 15 to provide to user 12, because the time spent by the professional 15 (and resultant cost to user 12) to act in place of expert system 30 is not time efficiently spent. All the while using expert system 30, the professionals 15 of association 10 are being presented to such user 12 and a certain amount of “inclination” is being generated in user 12 towards them, with the ultimate purpose being that user 12 contacts a professional 15 to review, for a fee, the Professional End Product 46 thus produced or to otherwise professionally engage a professional 15 on some other legal matter. Also, user 12 may require more professional services than originally thought, or may require services ancillary to the Professional End Product 46 itself (for example wills storage, or keeping corporate minute books).

It may be that user 12, after using expert system 30, obtains a Professional End Product 46 that is only partially complete and requires further modification before being usable (query step 230). Expert system 30 may provide such partially complete Professional End Products 46 in some common scenarios when users 12 interact with any expert system, whether of this invention or otherwise. One scenario is that user 12 stopped prematurely inputting in response to expert system 30's query process, simply because user 12 was tired or was unable to answer a query because user 12 did not have the information or didn't even understand the query. Another scenario is that the end product actually desired by user 12 is beyond what expert system 30 can produce. For example, user 12 wants a Professional End Product 46 which is a complex will that relates to properties situated in several jurisdictions, each with differing legal regimes. Although expert system 30 creates an end product that looks like a will, expert system 30 is not capable of producing such a will and so the produced document is not a useable Professional End Product 46 (i.e. is not usable as a will) in that condition. In such cases of a partially completed Professional End Product 46, user 12 will need professional services to complete the Professional End Product 46. For the purposes of this specification and appended claims (and not for the purpose of describing prior art), such a partially complete document is still considered a Professional End Product 46.

To obtain assistance and render usable a partially complete Professional End Product 46, user 12 may contact a professional 15 (step 240). As the Professional End Product 46 has already been partially completed, the time spent by the professional 15 to complete the Professional End Product 46 may in some situations be reduced, thereby making the professional 15 more efficient (relative to starting from the beginning with a potential client who did not bring in a document whose basic content the professional was already familiar with), and any efficiency might be reflected in a reduced fee, reflective of that efficiency, for the final product.

More generally, the professional 15 may offer his professional services on terms that reflect the utility of any Professional End Product 46 (whether complete or partially complete); i.e. users 12, i.e. who have a Professional End Product 46, enjoy “preferred” status and enjoy “preferred terms”. In association 10, it might be that all professionals 15 agree, as a condition of membership, to extend such preference to such users 12.

User 12's input when interacting with expert system 30 may be protected using means known in the art so that such input, which may include personal information of user 12, will be available only to user 12. In one embodiment, such input and the resulting PEP will not be stored within hardware/software implementing expert system 30. In such a case, input of user 12 will be revealed to the professional 15 with which user 12 is interacting, only by user 12 disclosing such input directly or providing the Professional End Product 46, to professional 15 in person. In another embodiment, expert system 30 is adapted to store such input and Professional End Product 46 and allows user 12 to electronically give a selected professional 15 access to such input or Professional End Product 46.

The present invention takes advantage of improvements in modem technology and the improvement in the average person's use thereof (e.g. increased use of personal computers and of word processing software; surfing the World Wide Web for free information; and the like). A professional's ability to charge for his services is based on both his expertise, experience and access to the information necessary to ply the professional's craft (e.g. the legal profession, where to find the appropriate precedent, statute, or case law). As this sort of information has become much more accessible through free databases, users 12 in the general public are less willing to pay for information they can access themselves.

This ability of users 12 to self-service their professional needs even partially, can be taken advantage of by using the method according to the invention. Furthermore, frequent dissatisfaction with the costs of obtaining professional services would be minimized as users 12 could do some of the work themselves and thereby focus the professional's time spent to that on issues beyond the capability of user 12. From the professional's point of view, the work performed for user 12 using the invention would be at a higher skill level as user 12 would have performed some or all of the “legwork” himself, without taking unnecessary time of the professional 15. Furthermore, from a risk or liability viewpoint, another advantage to the professional 15 is that user 12 takes the responsibility of the work done by himself, rather than passing such liability on to the professional 15.

The association 10 of professionals 15 allows the professionals 15 therein to pool their resources for marketing and branding their services. Organizer 20 may have the responsibility of promoting expert system 30. As expert system 30 should function as a revenue generator for the professionals 15 by attracting users 12 to become clients, it is not necessary that it directly generate revenue from users 12 or from third parties (e.g., there is no need to sell advertising space on expert system 30). Furthermore, professionals 15 in association 10 will have access to expert system 30, which, in its creation and maintenance, incorporates the knowledge of the other professionals 15. Therefore each professional 15 in association 10 can take advantage of the skills, experiences and efforts of other association professionals 15.

While the principles of the invention have now been made clear in the illustrated embodiments, it will be immediately obvious to those skilled in the art that many modifications may be made of structure, arrangements, and algorithms used in the practice of the invention, and otherwise, which are particularly adapted for specific environments and operational requirements, without departing from those principles. The claims are therefore intended to cover and embrace such modifications within the limits only of the true spirit and scope of the invention.

What is claimed is:

1. A method for a professional to attract clients by marketing to those who have no prior professional relationship with said professional, comprising the steps of:
(a) providing at no charge to a public user, the use of an expert system;
(b) said expert system providing a Professional End Product in response to said user's input;
(c) providing means for facilitating said user's communication with said professional;
(d) inviting said user to communicate with said professional to discuss the provision of professional services for a fee.

2. The method of claim 1, wherein said professional, in the course of performing professional services for a fee for said user, uses said user input.

3. The method of claims 1 or 2, further comprising the step of organizing an association of members, one of whose members is said professional.

4. The method of claim 3, further compromising the step of said association maintaining said expert system.

5. The method of claim 3, wherein said association retains an organizer and further comprising the step of said organizer maintaining said expert system.

6. The method of claim 3, wherein all members of said association are professionals of the same profession.

7. The method of claim 6, wherein said one same profession is regulated by geographical factors, and said expert system is adapted to be sensitive to local variations necessary for said user input to be relevant in a location specified by said user.

8. The method of claim 3, wherein membership in said association requires a commitment to a predefined standard for the provision of professional services.

9. The method of claim 8, wherein said predefined standard is ISO9002.

10. The method of claim 8, wherein said predefined standard is the provision of professional services whose cost and quality reflects the utility of said user input.

11. The method of claim 3, wherein each said association member contributes money or services said association as a condition of membership in said association.

12. The method of claim 3, wherein said step of providing use of an expert system, is implemented by a website and associated software.

13. The method of claim 3, wherein said step of providing means for facilitating said user's communication with said professional, is implemented by the presentation of the identities of said association professionals and their contact coordinates.

14. The method of claim 13, wherein said presentation of professionals is prioritized depending on said specified location and on the said user's interest.

15. The method of claim 15, wherein said implemented presentation include electronic links to said association members.

16. The method of claim 3, wherein said one professional is a legal professional.

17. The method of claim 3, wherein one said association member is a professional of one profession and another said association member is a professional of another profession.

18. The method of claim 3, wherein one said association member is a professional and one said association member is not a professional.

19. The method of claim 3, wherein said user's input is kept confidential under said user's exclusive control.
